(19) United States
(12) Patent Application Publication
(10) Pub. No.: US 2005/0252849 A1
(43) Pub. Date: Nov. 17, 2005

(54) Method of manufacturing oil filter module by use of a laser

(75) Inventors: Allen B. Wright, Hope Mills, NC (US); Ledu Quoc Nguyen, Orlando, FL (US)

Correspondence Address: BARNES & THORNBURG, 11 SOUTH MERIDIAN, INDIANAPOLIS, IN, 46204, US

(73) Assignee: Arvin Technologies, Inc.

(21) Appl. No.: 11/188,508

(22) Filed: Jul. 25, 2005

Related U.S. Application Data
(63) Continuation-in-part of application No. 10/147,252, filed on May 16, 2002.

(51) Int. Cl. B01D 29/07

(52) U.S. Cl. 210/450; 210/454; 210/493.2; 29/896.62

(57) ABSTRACT

A method of manufacturing an oil filter module comprises directing a laser beam at a surface of an end cap but not at a rim of the end cap so as to fuse at least a portion of the end cap, spacing the end cap and the filter medium apart from one another during the directing step, inserting an end of the filter medium into the laser-fused portion so as to bond the end of the filter medium and the end cap together upon re-solidification of the laser-fused portion, and preventing flow of the laser-fused portion caused by the inserting step from reaching a peripheral diameter of the end cap by use of the rim.

This application claims the benefit as a continuation-in-part of U.S. patent application Ser. No. 10/147,252 which was filed on May 16, 2002 and is hereby incorporated by reference herein.

### FIELD OF THE DISCLOSURE

The present disclosure relates to filters and, in particular, to filters for vehicular fluids and methods of manufacturing such filters.

### BACKGROUND OF THE DISCLOSURE

Fluid filters are used to filter contaminants from fluids. Filters often include a filter module that includes a filter medium through which the fluid to be filtered flows. The filter module fits in a housing. The fluid flows into the housing on one side of the filter medium, passes through the medium to the other side of the filter medium, and exits the housing. Contaminants are trapped by the filter medium.

In one common arrangement, the filter medium includes pleated filter material. The pleated material is formed into a cylinder having outer and inner side walls. The ends are then sealed. Fluid introduced into the inside of the filter then flows through the filter medium from the inner side wall to the outer side wall or vice versa. End caps for sealing the ends of the filter medium cylinder have been coupled to the ends using adhesives.

### SUMMARY OF THE DISCLOSURE

According to an aspect of the present disclosure, a method of manufacturing an oil filter module comprises directing a laser beam at a surface of an end cap but not at a rim of the end cap so as to fuse at least a portion of the end cap. The end cap and the filter medium are spaced apart from one another during the directing step. An end of the filter medium is inserted into the laser-fused portion so as to bond the end of the filter medium and the end cap together upon re-solidification of the laser-fused portion. The rim is used to prevent flow of the laser-fused portion caused by the inserting step from reaching a peripheral diameter of the end cap (e.g., an outer diameter or an inner diameter). In this way, the size of the peripheral diameter can be maintained.

According to another aspect of the present disclosure, the filter medium comprises an annular well defined by an outer rim extending along an outer diameter of the end cap, an inner rim extending along an inner diameter of the end cap, and a well bottom surface extending between the outer and inner rims at the bottom of the well. In such a case, the method comprises directing the laser beam at the well bottom surface but not at the outer and inner rims to provide the laser-fused portion. The outer and inner rims are used to limit flow of the laser-fused portion caused by insertion of the filter medium into the laser-fused portion so that the flow does not reach the outer diameter and does not reach the inner diameter.

The above and other features of the present disclosure will become apparent from the following description and the attached drawings.

### BRIEF DESCRIPTION OF THE DRAWINGS

The detailed description particularly refers to the accompanying figures in which:

FIG. 1 is an exploded perspective view of a fluid filter, showing a filter housing and a filter module including a filter medium formed into a pleated cylindrical filter element and a pair of end caps spaced from the ends of the filter element;

FIG. 2 is a partial sectional view showing the filter assembled, the end caps bonded to the ends of the filter element forming a filter module, the filter module in a filter chamber of the housing, and a filter closure securing the filter module in position in the chamber;

FIG. 3 is a fragmentary sectional view of the middle region of the end cap bonded to an end of the filter element;

FIG. 4 is a perspective view of a stationary laser emitting radiation energy in the form of a laser beam to fuse the middle region of the end cap;

FIG. 5 is a perspective view of a laser that rotates about an axis and emits radiation energy in the form of a laser beam to fuse the middle region of the end cap;

FIG. 6 is a perspective view of a laser that scans back and forth along a path and emits radiation energy in the form of a laser beam to fuse the middle region of the end cap;

FIG. 7 is a perspective view of a laser emitting radiation energy in the form of a laser beam to fuse the middle region of the end cap, and a masking apparatus positioned to block radiation energy to the inner and outer regions of the end cap and permit passage of radiation energy to the middle region;

FIG. 8 is a perspective view showing use of a laser beam emitted from a stationary laser to fuse a portion of a bottom surface of a well formed in an end cap;

FIG. 9 is a perspective view showing use of a laser beam emitted from a laser rotating about an axis of the end cap to fuse a portion of the well bottom surface;

FIG. 10 is a perspective view showing use of a laser beam that impinges upon the well bottom surface in a zig-zag pattern to fuse a portion of the well bottom surface;

FIG. 11 is a perspective view showing masking of inner and outer rims of the end cap during laser fusion of the well bottom surface; and

FIG. 12 is an enlarged sectional view showing use of the inner and outer rims to limit flow of the laser-fused portion so that the flow does not reach the inner and outer diameters of the end cap.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

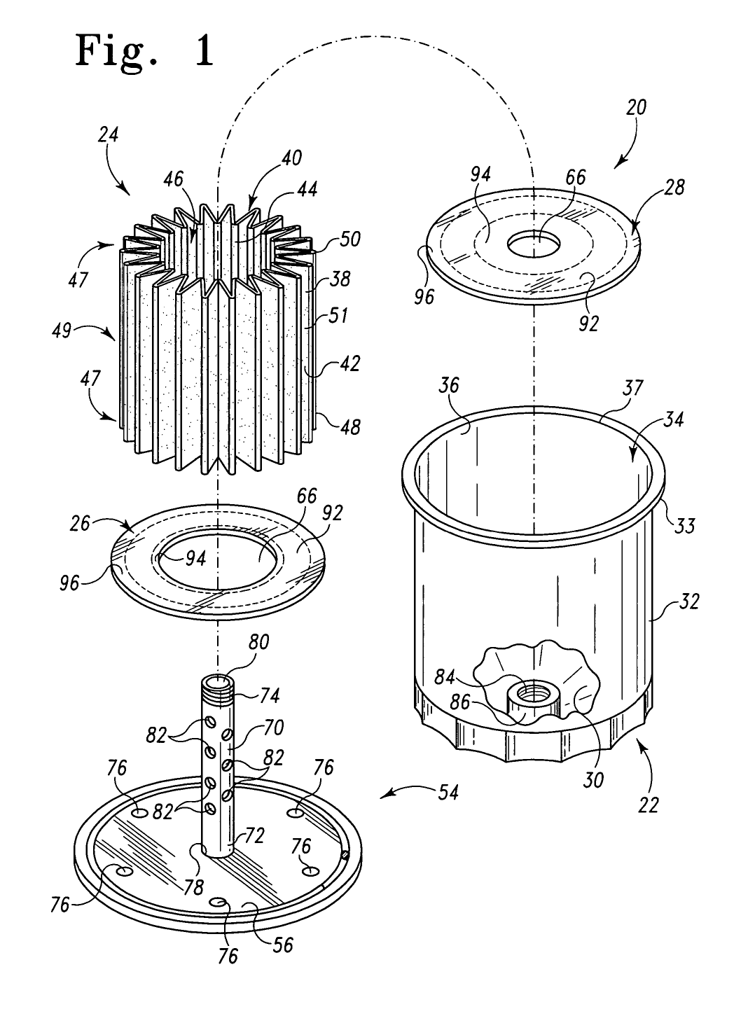

As illustrated in FIG. 1, a fluid filter 20 includes a filter housing 22 and a filter module 24 such as an oil filter module to filter contaminants from fluid such as oil flowing through housing 22. Filter module 24 includes an annular filter medium 38 and first and second end caps 26, 28 bonded to filter medium 38. End caps 26, 28 may be used to form a seal with housing 22. The bonding of end caps 26, 28 prevents fluid from bypassing the filter medium 38.

End caps 26, 28 are made of a fusible material. To “fuse” is to reduce to a liquid or plastic state. End caps 26, 28 are fused and the ends 48, 50 of filter medium 38 are bonded to end caps 26, 28. Illustratively, filter module 24 is constructed so that no additional components are needed to create the seal between housing 22 and filter medium 38. However, it is within the scope of this disclosure to include gaskets or the like to reduce the likelihood of leakage between end caps 26, 28 and housing 22.

End caps 26, 28 are shaped to cooperate with end regions 47 of filter element 40 to prevent the fluid from bypassing filter medium 38 and passing between end regions 47 and housing 22. Illustratively, each end cap 26, 28 is generally flat disk-shaped and includes a central opening 66. End caps 26, 28 are attached to filter element 40 with openings 66 aligned axially of element 40, as illustrated in FIG. 2.

As illustrated in FIG. 1, filter element 40 includes a central region 49 between end regions 47. Filter element includes an outer surface 42 facing radially outwardly from axis 41 of element 40 and an opposite inner surface 44 facing radially inwardly. Inner surface 44 defines a central region 46 into which filtered fluid flows after passing through filter medium 38. While a pleated filter element 40 is shown, it is to be understood that filter element 40 can assume any suitable shape or configuration.

As illustrated in FIG. 1, housing 22 includes an end wall 30 and a side wall 32 extending from end wall 30 and cooperating therewith to form a filter chamber 34. Side wall 32 terminates at a distal end 36 spaced from end wall 30 to border an opening 37 through which filter module 24 can be inserted and removed.

As illustrated in FIG. 2, fluid filter 20 includes a filter closure 54 providing the fluid inlet and outlet to housing 22. Closure 54 is coupled to a center tube 70 at one end 72 of the center tube 70. The other end 74 of tube 70 is threaded, as shown in FIGS. 1 and 2. Closure 54 includes one or more inlets, illustratively a plurality of inlet holes 76 formed around closure 54 at (a) distance(s) from axis 41 that places them outside of filter module 24 in the assembled filter 20. Outlet port 78 of filter 20 communicates with a passageway 80 that extends through tube 70. As illustrated in FIGS. 1 and 2, tube 70 includes a plurality of inlet openings 82 formed therein to permit filtered fluid to flow from filter 20 through outlet port 78.

As illustrated in FIGS. 1 and 2, filter module 24 is retained in chamber 34 by a filter closure 54. Filter closure 54 is illustrated in FIG. 1 as a filter bottom 56 that is coupled to filter housing 22 to form filter assembly 20. Filter closure 54 is illustrated in FIG. 2 as a filter mounting plate 58 provided, for example, on an engine block (not shown). Housing 22 and filter closure 54 are coupled together to maintain filter module 24 in chamber 34. Illustratively, filter closure 54 and distal end 36 of side wall 32 are placed adjacent each other so that center tube 70 extends through opening 66 of each end cap 26, 28 and through central region 46 of filter element 40. Illustratively, threaded end 74 of center tube 70 is coupled to a threaded aperture 84 formed in boss 86 coupled to end wall 30, securing closure 54 to housing 22. However, any suitable method of coupling housing 22 and filter closure 54 is within the scope of this disclosure.

As shown in FIGS. 1 and 2, a gasket 88 is coupled to closure 54 and engages distal end 36 of side wall 32, illustratively engaging a radially outwardly projecting flange 33 provided at distal end 36. Flange 33 engages gasket 88 to seal distal end 36 to closure 54.

As illustrated in FIG. 2, a seal is formed between filter element 40 and housing 22 to prevent the fluid from bypassing filter medium 38 and flowing over end 50 of filter element 40 into port 78. End cap 28 seals against boss 86 to provide the seal between end 50 and housing 22. It is within the scope of this disclosure for end cap 28 to engage end wall 30 or another structure coupled to housing 22 to provide a seal between housing 22 and filter medium 38. It is within the scope of this disclosure to provide a gasket or other means to cooperate in forming a seal between end cap 28 and boss 86 or end wall 30. End cap 26 seals against filter closure 54 to prevent fluid from bypassing filter medium 38 and flowing over end 48 of filter medium 38 into port 78. It is within the scope of this disclosure to provide a gasket to cooperate in forming a seal between end cap 26 and filter closure 54.

As shown by the directional arrows indicating flow of fluid in FIG. 2, fluid enters filter 20 through inlet holes 76 in closure 54 and passes through opening 37 into chamber 34. The fluid then passes through filter medium 38 into the interior 46 of filter element 40. The fluid then passes into inlet openings 82 formed in tube 70, through passageway 80, and through outlet 78 in closure 54.

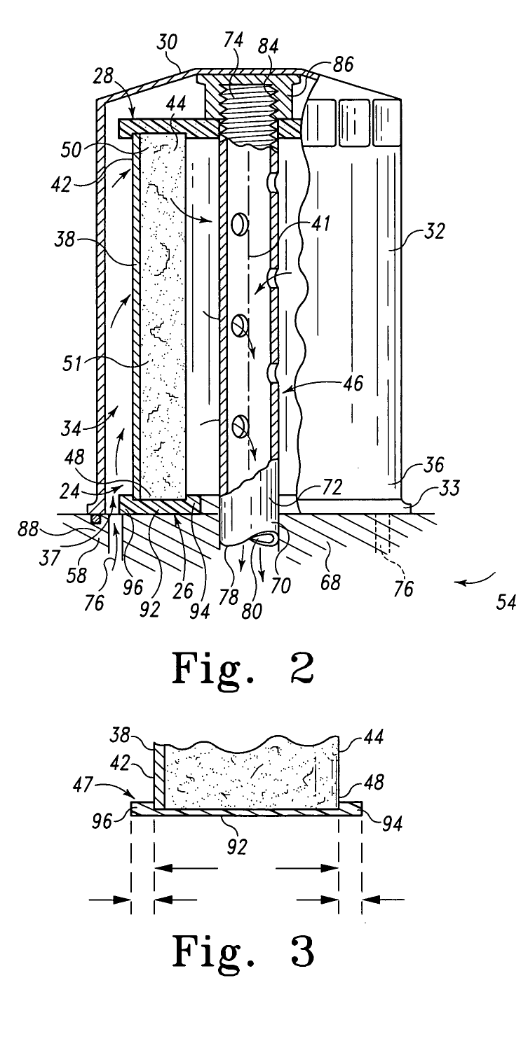

As illustrated in FIGS. 2 and 3, end caps 26, 28 are coupled to ends 48, 50 of filter element 40, respectively. End caps 26, 28 are constructed from (a) fusible material(s) such as a fusible resin or polymer. An energy source, illustratively a laser 90, applies energy to a middle region 92 of each of end caps 26, 28 to fuse middle region 92. Ends 48, 50 of filter element 40 are then inserted into, or otherwise applied to, the fused middle region 92. Upon solidifying or hardening of middle region 92, the end caps 26, 28 are sealed and coupled to ends 48, 50.

As illustrated in FIGS. 3-7, each end cap 26, 28 includes a middle region 92 bounded by an inner region 94 adjacent central opening 66 and an outer region 96 adjacent the periphery of end cap 26 or 28. Laser 90 fuses only middle region 92. As illustrated in FIG. 3, middle region 92 has sufficient radial width to accommodate filter medium 38. Inner and outer regions 94, 96 remain unfused so that, when filter element 40 is inserted into the fused middle region 92, undesired radially inward or outward flow of the fused middle region 92, or flash, is minimized. Inner and outer regions 94, 96 dam the flow of the fused material displaced from middle region 92 when element 40 is applied to fused middle region 92.

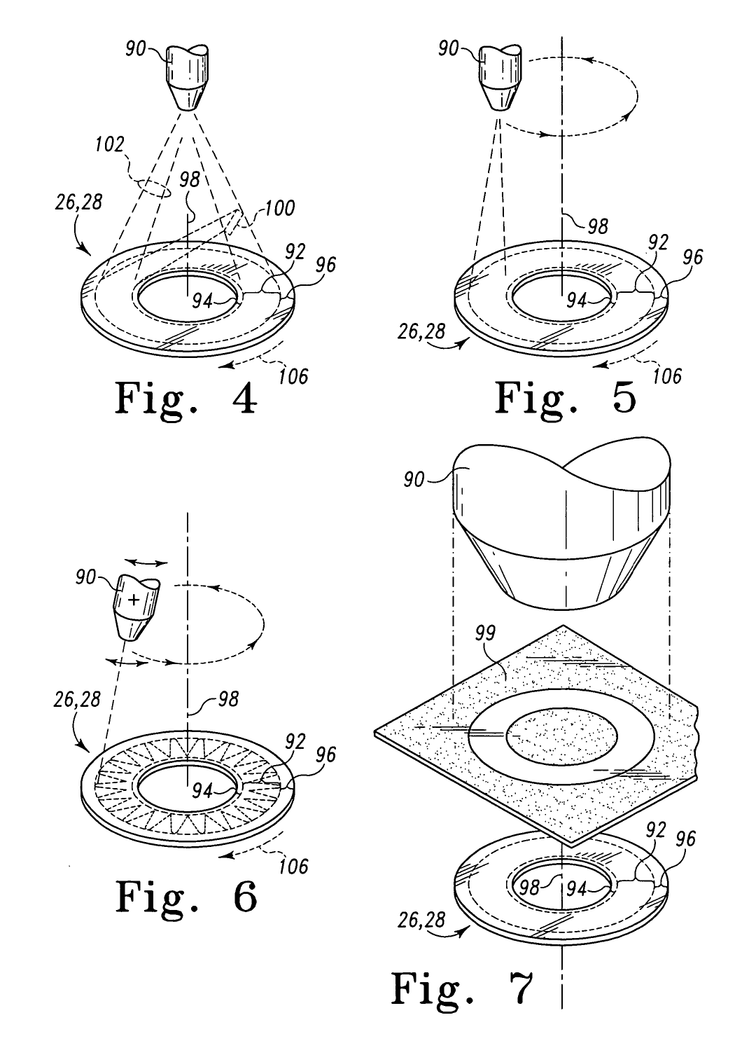

As illustrated in FIGS. 4-7, middle region 92 of each of end caps 26, 28 can be fused by directing energy from the source at middle region 92 and not directing it at inner or outer regions 94, 96. FIG. 4 suggests directing energy in the form of radiation emitted from laser 90 at middle region 92 using mirrors (e.g., mirror 100) and/or lenses (e.g., lens 102) so that the energy is focused on the middle region 92. FIG. 5 illustrates relative movement between an energy source 90, such as a laser emitting energy in the form of radiation (e.g., a laser beam), and an end cap 26, 28 so that such energy is directed at or around middle region 92 but not an inner and outer regions 94, 96, resulting in fusing the middle region 92 of each end cap 26, 28. The relative movement can be achieved by rotating each end cap 26, 28 about a central axis 98 as suggested by direction arrow 106. Alternatively, laser 90 may be moved about axis 98 to fuse middle region 92. FIG. 6 illustrates a composite relative motion including both relative rotation and tilting to provide a scanning of the energy source 90 back and forth across the width of middle region 92. Again, this relative rotation and tilting can be achieved by moving one or the other or both of energy source 90 and end cap 26 or 28, although it may most straightforwardly be achieved by rotating the end cap 26 or 28 (as suggested by direction arrow 106) about its axis 98 while simultaneously tilting or “wobbling” the energy source 90. The laser beam can thus be caused to impinge upon middle region 92 in a zig-zag pattern around axis 98. FIG. 7 illustrates using a masking apparatus 99 to mask the inner and outer regions 94, 96 from the energy source 90. As a result, only middle region 92 is fused. Any suitable energy source 90 having sufficient output power to fuse middle region 92 is within the scope of this disclosure.

A laser is currently contemplated as the energy source 90 of choice, but it is within the scope of this disclosure to use other energy sources such as infrared lamps, resistance heaters, and the like to fuse regions 92. It is also within the scope of this disclosure to construct end caps 26, 28 from any material that is non-reactive with the fluid to be filtered and other environmental requirements such as thermal and/or mechanical shock resistance and that permits focused energy to selectively fuse middle region 92 without fusing inner and outer regions 94, 96. It is understood that some heat transfer between middle region 92 and inner and outer regions 94, 96 will occur, and that some amount of fusing of the inner and outer regions 94, 96 may result, and is acceptable.

End caps 26, 28 may be constructed using any suitable fusible material which permits filter medium 38 to be applied thereto. Upon hardening or solidification of middle region 92, the end cap 26, 28 cooperates, bonds, captures, or becomes integral with, filter medium 38. Filter medium 38 may comprise any suitable filtration material such as, for example, cellulose, a cellular polymeric material, a metal wool, or other suitable material.

The method for manufacturing and/or assembling fluid filter 20 includes fusing a middle region 92 by applying to middle region 92 energy from the energy source 90. Once region 92 is fused, one of ends 48, 50 is of filter element 40 is applied to middle region 92. Middle region 92 then re-solidifies, bonding the end cap 26, 28 to the respective end 48, 50. This process is also performed to bond the other of the end caps 26, 28 to the other of ends 48, 50.

While somewhat disk-shaped end caps 26, 28 are illustrated, it is within the scope of this disclosure to provide one or both of end caps 26, 28 in any shape suitable for the construction of filter element 40. It is also within the scope of this disclosure to fuse the middle regions 92 of both end caps 26, 28 at the same time and assemble the filter element 40 all at once, or at different times and assemble the filter element 40 sequentially. Although filter medium 38 is illustrated as a pleated structure incorporated into a cylindrical element 40, filter medium can be provided in any suitable configuration to cooperate with appropriately configured end caps 26, 28 and filter housing 22 to filter fluid flowing therethrough. Additionally, it is within the scope of this disclosure to use the apparatus and method disclosed herein as or with any fluid filter, including engine and transmission oil filters, hydraulic fluid filters, air filters, fuel filters, and other filters.

Referring to FIGS. 8-12, there is shown an annular end cap 126 for use as each of the end caps 26, 28 in the filter module 24. Instead of being flat like the end caps 26, 28, the end cap 126 has a well 130 formed therein between outer and inner rims 132, 134 protruding axially from a well bottom surface 136 of the well 130 relative to the axis 98. Each rim 132, 134 extends along a peripheral diameter of the end cap 126. In particular, the outer rim 132 extends along an outer diameter 138 of the end cap 126 and the inner rim 134 extends along an inner diameter 140 of the end cap 126.

During manufacture of the filter module 24, a laser beam 142 of the laser 90 is directed at the well bottom surface 136 but not at the outer rim 132 and not at the inner rim 134. In this way, at least a portion of the surface 136 is fused by the laser beam 142. The end cap 126 and the filter medium 38 are spaced apart from one another during the time that the laser beam 142 is directed at the surface 136. An end 48 of the filter medium 38 is then inserted into the laser-fused portion of the end cap 126 so as to bond the end 48 of the filter medium 38 and the end cap 126 together upon re-solidification of the laser-fused portion. The outer rim 132 prevents flow of the laser-fused portion caused by insertion of the end 48 (i.e., flash) from reaching the outer diameter 138. Similarly, the inner rim 134 prevents flow of the laser-fused portion caused by insertion of the end 48 (i.e., flash) from reaching the inner diameter 140.

As such, use of the laser beam 142 in combination with one or both of the rims 132, 134 helps to maintain the size of the respective diameters 138, 140. In particular, use of the laser beam 142 reduces the amount of flash generated in the first place while use of one or both of the rims 132, 134 blocks flow of the relatively small amount of flash which may be generated by the laser beam 142 to the respective diameters 138, 140. In this way, the size of the diameters 138, 140 is not altered by flash produced upon insertion of the end 48 into the laser-fused portion. This may be especially useful in applications where the specific size of one or both of the diameters 138, 140 of the end cap 126 is of interest.

Referring to FIG. 8, there is shown a relatively broad laser beam 142 of the laser 90 directed at the well bottom surface 136 but not at the outer and inner rims 132, 134 by use of at least one mirror 100 and/or at least one lens 102. In such a case, the laser 90 is stationary and the laser beam 142 is directed around the axis 98 to impinge on the well bottom surface 136 therearound by use of the equipment 100, 102. The end cap 126 may also be stationary or may be simultaneously rotated about the axis 98 as suggested by direction arrow 106. The well bottom surface 136 is thus fused around the axis 98 for subsequent insertion and securement of the end 48 of the end cap 126 to the well bottom surface 136.

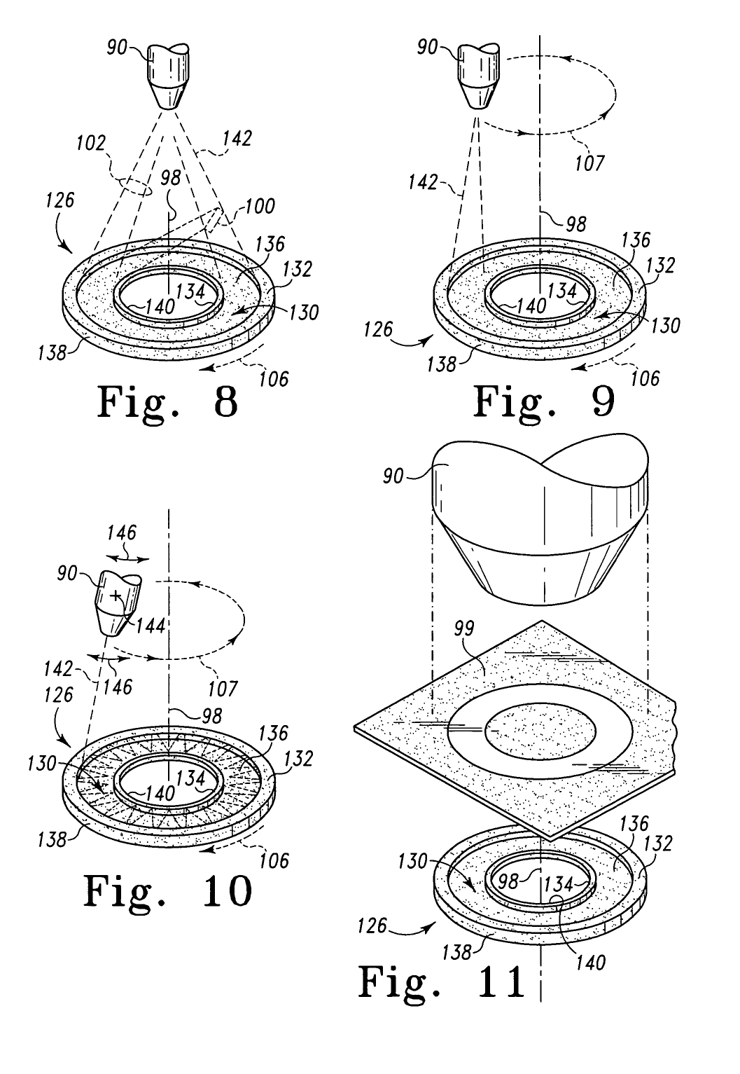

Referring to FIG. 9, there is shown another method of fusing the well bottom surface 136 but not the rims 132, 134. In particular, the laser 90 and/or the end cap 126 are/is rotated about the axis 98 as suggested by direction arrows 107, 106. In this way, a relatively broad laser beam 142 of the laser 90 is directed at the well bottom surface 136 around the axis 98 so as to fuse the surface 136 therearound for subsequent insertion and securement of the end 48 of the end cap 126 to the surface 136.

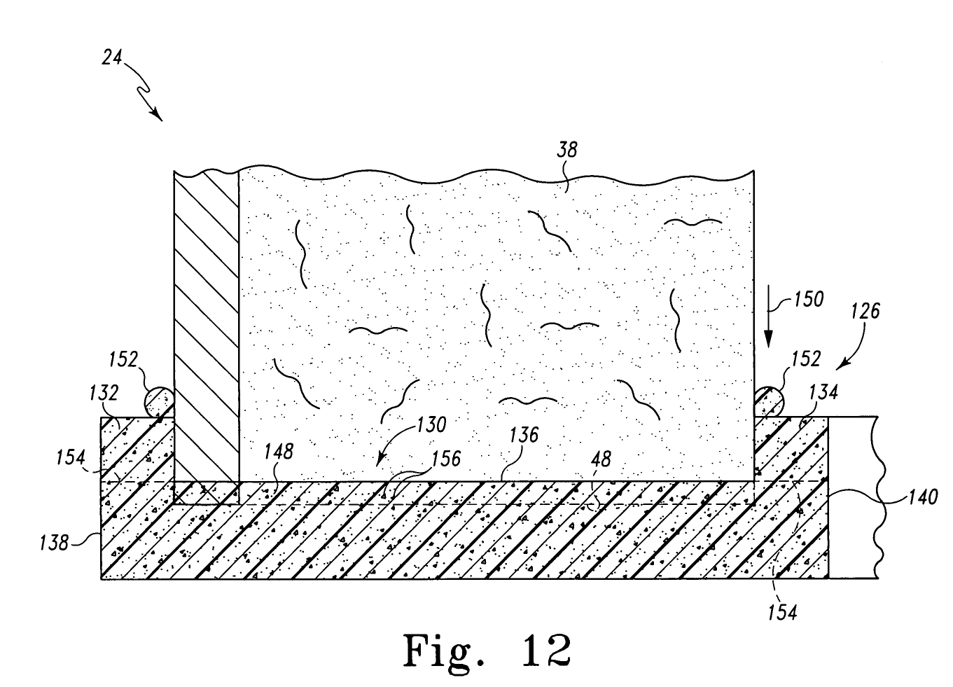

Referring to FIG. 10, there is shown yet another method of fusing the well bottom surface 136 but not the rims 132, 134. In particular, the laser 90 is “wobbled” or otherwise oscillated back and forth about an axis 144 as suggested by double-headed direction arrow 146 while the laser 90 and/or the end cap 126 are/is rotated about the axis 98 as suggested by direction arrows 107, 106. In this way, a relatively narrow laser beam 142 of the laser 90 is scanned back and forth in a zig-zag pattern on the well bottom surface 136 around the axis 98 so as to fuse the surface 136 therearound for subsequent insertion and securement of the end 48 of the end cap 126 to the surface 136.

Referring to FIG. 11, there is shown use of the masking apparatus 99 for masking the outer and inner rims 132, 134 while exposing the well bottom surface 136 for contact with the laser beam 142. In this way, the rims 132, 134 are protected from contact with the laser beam 142 while allowing fusion of the well bottom surface 136 by the laser beam 142.

Referring to FIG. 12, there is shown the end 48 of the filter medium 38 inserted into the laser-fused portion 148 of the well bottom surface 136, as suggested by insertion arrow 150. The end cap 126 is illustratively made of a polymer (e.g., propylene or nylon) which mechanically bonds with the filter medium 38 upon re-solidification of the laser-fused portion 148.

Insertion of the end 48 of the filter medium 38 into the laser-fused portion may produce flash 152. In particular, insertion may produce a radially outward and/or radially inward flow of the laser-fused portion 148 toward one or both of the diameters 138, 140. In such a case, the rims 132, 134 prevent the flash 152 from reaching the respective diameters 138, 140 so as to maintain the integrity of the size of the diameters 138, 140.

Illustratively, each rim 132, 134 is annular so as to extend all the way around the axis 98. Alternatively, each rim 132, 134 may extend only partially around the axis 98 or may include a plurality of parts positioned about the axis 98 to block flow toward the diameters 138, 140. It is also within the scope of this disclosure for the end cap 126 to include only one of the rims 132, 134 instead of both rims 132, 134, as suggested by dashed lines 154 in FIG. 12.

The laser 90 may be any laser suitable for fusing the end cap 126 in a controlled manner. For example, the laser 90 may be constructed to generate a yellow CO₂ laser beam or a red-infrared laser beam. Such laser beams may be directed at a propylene, nylon, or other polymer portion of the surface 136 for fusion thereof.

The end cap 126 may be provided with a laser-absorption additive 156 for absorbing at least a portion of the laser beam 142 to promote fusion of the end cap 126. The additive 156 may be tailored to the frequency or frequencies of the laser 90 in the sense that the additive 156 may be selected so as to have an affinity for absorbing the particular frequency or frequencies of the laser beam 142 emitted by the laser 90. The additive 156 may take a variety of forms. For example, the additive 156 may include carbon black or other colorant(s). The end cap 126 may be constructed such that the additive 156 is present only in the zone to be fused or present throughout the end cap 126.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of manufacturing an oil filter module comprising an annular end cap and an annular filter medium for filtering contaminants from oil, the filter medium comprising a rim protruding axially from a surface of the end cap relative to an axis of the end cap and extending along a peripheral diameter of the filter medium, the method comprising the steps of:
directing a laser beam at the surface but not at the rim so as to fuse at least a portion of the end cap,
spacing the end cap and the filter medium apart from one another during the directing step,
inserting an end of the filter medium into the laser-fused portion so as to bond the end of the filter medium and the end cap together upon re-solidification of the laser-fused portion, and
preventing flow of the laser-fused portion caused by the inserting step from reaching the peripheral diameter by use of the rim.

2. The method of claim 1, wherein the directing step comprises scanning the laser beam back and forth on the surface but not on the rim.

3. The method of claim 1, wherein the directing step comprises using one or both of a mirror or a lens with the laser beam to cause the laser beam to impinge on the surface but not on the rim.

4. The method of claim 1, comprising masking the rim during the directing step.

5. The method of claim 1, wherein the directing step comprises directing a yellow CO₂ laser beam or a red-infrared laser beam at a propylene or nylon portion of the surface of the end cap.

6. The method of claim 1, wherein:
the rim extends along an outer diameter of the end cap, and
the preventing step comprises preventing the flow from reaching the outer diameter by use of the rim.

7. The method of claim 1, wherein:
the rim extends along an inner diameter of the end cap, and
the preventing step comprises preventing the flow from reaching the inner diameter by use of the rim.

8. The method of claim 1, wherein:
the end cap comprises a polymer and a laser-absorption additive in the polymer, and
the directing step comprises the laser-absorption additive absorbing at least a portion of the laser beam.

9. The method of claim 8, wherein:
the laser-absorption additive comprises carbon black, and
the absorbing step comprises the carbon black absorbing at least a portion of the laser beam.

10. The method of claim 8, wherein:
the laser-absorption additive comprises a colorant, and
the absorbing step comprises the colorant absorbing at least a portion of the laser beam.

11. A method of manufacturing an oil filter module comprising an annular end cap and an annular filter medium for filtering contaminants from oil, the filter medium comprising an annular well defined by an outer rim extending along an outer diameter of the end cap, an inner rim extending along an inner diameter of the end cap, and a well bottom surface extending between the outer and inner rims at the bottom of the well, the method comprising the steps of:
directing a laser beam at the well bottom surface, but not at the outer rim and not at the inner rim, so as to fuse at least a portion of the end cap,
spacing the end cap and the filter medium apart from one another during the directing step,
inserting an end of the filter medium into the laser-fused portion so as to bond the end of the filter medium and the end cap together upon re-solidification of the laser-fused portion, and
preventing flow of the laser-fused portion caused by the inserting step from reaching the outer diameter by use of the outer rim and from reaching the inner diameter by use of the inner rim.

12. The method of claim 11, comprising relatively rotating the end cap and the laser beam.

13. The method of claim 12, wherein the relative rotation step comprises causing the laser beam to impinge upon the well bottom surface around a central axis of the end cap.

14. The method of claim 13, wherein the relative rotation step comprises causing the laser beam to impinge upon the well bottom surface in a zig-zag pattern around the central axis.

15. The method of claim 11, wherein the directing step comprises scanning the laser beam back and forth on the well bottom surface.

16. The method of claim 11, wherein the directing step comprises using one or both of a mirror or a lens with the laser beam to cause the laser beam to impinge on the well bottom surface.

17. The method of claim 11, comprising masking the outer and inner rims during the directing step.

18. The method of claim 11, wherein:
the laser-fused portion of the well bottom surface comprises a polymer, and
the inserting step comprises mechanically bonding the polymer of laser-fused portion of the well bottom surface with the end of the filter medium upon re-solidification of the laser-fused portion of the well bottom surface.
